(19) United States
(12) Patent Application Publication
(10) Pub. No.: US 2023/0024416 A1
(43) Pub. Date: Jan. 26, 2023

(54) System for Roof Monitoring

(71) Applicant: Wayne Ainscow, St. Albert AB (CA)

(72) Inventor: Wayne Ainscow, St. Albert AB (CA)

(21) Appl. No.: 17/381,959

(22) Filed: Jul. 21, 2021

(51) Int. Cl. G08B 25/01

(52) U.S. Cl. CPC G08B 25/014; G08B 25/016

(57) ABSTRACT

The present invention is a system for roof top monitoring that includes a main body housing primary components that are operatively associated with a computer and communications system configured for each of monitoring the primary components and broadcasting an alert based on actuation of any of the primary components.

### BACKGROUND OF THE INVENTION

The roofing industry is very much a specialty in the construction arts. There are very significant details that are often the difference between a roof that lasts for many years and a roof in constant need of repair.

Roofing often involves application of tar and other components that must be applied at high temperatures. For example, roofing asphalt must be heated to between 54-173° C.

As the roof cools, there is a clear and present danger of fire being started on the roof.

Most major losses by fire happen are a result of zero monitoring after hours. By the time anyone is alerted it's too late to avoid major fire, smoke, and water damage. At 2 am on a Wednesday, if a tall building catches fire, an observer on the ground will no smoke and the flame is only visible once it's close to two stories high.

In another possible scenario, in completing torch work, bits of insulation and board light up and smolder through the day, then come late night or early morning they “pop” and a real fire flares up.

There is a need for a roof top monitoring system to avoid the costly roof fires that are common

The present invention addresses this need.

### SUMMARY OF THE INVENTION

In one embodiment, the system will reduce or eliminate full asset loss going forward, with an emergency alert programed to call first responders.

Any one or combination of the following are contemplated as being incorporated with the system of the present invention:

Simple programable robot that will sever multiple safety and security functions;

Flash detection (fire eyes)—thermal/IR lenses—live feed with simple programing;

Emergency 911 button that can be preprogramed—allows anyone in the area to get help during an emergency—GPS in the unit will help first responders;

Tri pod should work will with counter weights or screws, clamps allow the system to be installed once and not have to be moved daily;

Upgraded units would have h2s and s02 gas detection option and intrinsically safe options;

Satellite cameras can cover more area on the site, Bluetooth connection or wire option to the main base unit for reporting;

3rd party call center as an option for alert, like home security as a back up;

Color is to be in bright orange or yellow.

The system is contemplated as configured with any one or more of the following environments of use:

roofing, welding and all other Hot work done in the industrial, commercial and residential market;

for temporary hot watch on apartments, hospitals, prisons; site security, a person can now be notified when someone is on a site they shouldn't be on, the cover of night won't work with the thermal, security can now contact police with accurate info and not risk having to confront a perp;

An option to be able to set off an alarm and light show to scare off people;

Industrial and commercial markets like refinery's have flame detection that shuts down systems in case of an issue, if you are doing hot work on site, they need to shut down this flame detector, this leaves the site venerable, this temporary system could be put in just to alert an operator of a potential issue, this is not an action but more of an option to act if needed.

Programing the system with any one or more of the following:

Simple programing screen—address of site—3 contact numbers—local emergency number—Hight of building—type of work completed—substrate (concrete, wood, steel etc.);

Simple live feed option to check on sites after hours, or keep an eye on your guys during work;

Emergency text app—sends warning to programed staff numbers—it will ask if this is an emergency—you press yes, then it will put you in contact with emergency services—if you press no, it will ask for an explanation of the false alarm. While the app puts you in touch with emergency services it displays all of the info on the job—address—building height etc.

The physical structure is contemplated as encompassing any combination of:

Counterweight tripod system or secure fix to structure Lenses protection against topple over;

Flashing light/beacon on top with an option for a siren;

H2S monitor;

S02 Monitor;

Wind meter—Anemometer;

Call center live link;

Live camera for call center and user to view roof or site live to confirm fire or wind damage;

Solar panel for energy source for unit;

GPS locator (within 10 ft location);

App to smartphones for easy viewing;

Carbon monoxide detector;

Flash detector;

Infrared detector;

Low light or night vision camera for night time viewing for live view;

Audio mic for listening in on live view;

Intrinsically safe;

Emergency button on top for any time;

Attachment lenses to add more camera attachments for larger areas.

In one embodiment, the present invention is a system for roof monitoring comprising:
a main body housing constructed and arranged for placement on a roof;
primary components incorporated into said main body housing including any one or combination of anemometer, infrared detector, camera, flash detector, audio speaker, carbon monoxide monitor, sulfur dioxide monitor, hydrogen sulfide monitor, GPS location, light beacon, siren, microphone, and motion detector;
computer components operatively associated with said primary components and a communications systems;
legs positioned on an underside of said main body for supporting said main body.

In one embodiment, the main body is secured into portion with counterweights on a distal end of said legs.

In one embodiment, the main body is secured to an existing structure on a roof where said main body is placed.

In one embodiment, the existing structure is an air conditioner compressor or a rooftop pipe.

In one embodiment, the communications system broadcasts an alert when any of said primary components are actuated.

In one embodiment, the communications system are configured to provide remote monitoring of all primary components.

In one embodiment, the communications system broadcasts an alert to emergency first responders when any of said primary components are actuated.

In one embodiment, the present invention is a system for roof monitoring consisting of:
a main body housing constructed and arranged for placement on a roof;
primary components incorporated into said main body housing including any one or combination of anemometer, infrared detector, camera, flash detector, audio speaker, carbon monoxide monitor, sulfur dioxide monitor, hydrogen sulfide monitor, GPS location, light beacon, siren, microphone, and motion detector;
computer components operatively associated with said primary components and a communications system;
legs positioned on an underside of said main body for supporting said main body.

### BRIEF DESCRIPTION OF THE SEVERAL VIEWS OF THE DRAWINGS

FIG. 1 is a perspective view of a device in the system according to one embodiment of the present invention.

FIG. 2 is a perspective view of a device in environment of use, according to one embodiment of the present invention.

FIG. 3 is a perspective view of a device in environment of use, according to one embodiment of the present invention.

### DETAILED DESCRIPTION OF THE PREFERRED EMBODIMENTS

Although the accompanying figures provide an exemplary embodiment, the present invention is not limited to the specific shapes and configurations presented.

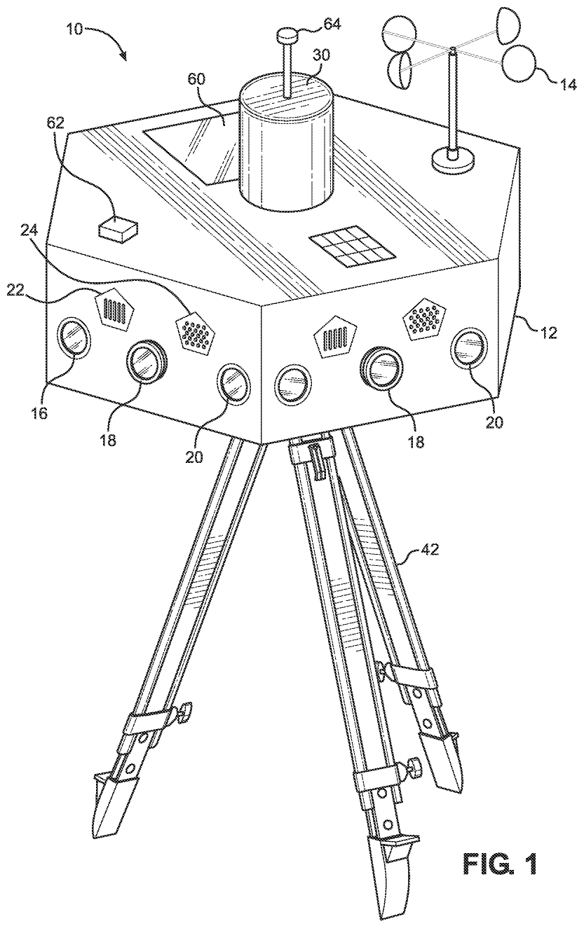

As demonstrated in FIG. 1, system 10 is constructed and arrange to pay positioned upon a roof. The system includes a main housing body 12 incorporating various features within a single main housing body. The system is contemplated as including any one or combination of the components presented herein. Main housing body 12 includes an anemometer 14 infrared detector 16 camera 18 and flash detector 20. Further incorporated into main housing body 12 is a first component housing 22 and a second component Housing 24. Each of first component housing 22 and second component housing 24 are constructed in the range to hold a plurality of sensors and monitors including carbon monoxide detector, sulfur dioxide monitor, hydrogen sulfide monitor and an audio speaker. The upper surface of main housing body 12 further includes an extended component housing 30. Component housing 30 is constructed and arranged to include communications, computer components, GPS components, light beacon, Siren, microphone, speaker, or combinations thereof.

In one embodiment, system 10 includes a video touchscreen 60.

In one embodiment, system 10 includes a manual emergency button 62. This is operatively associated with communications systems and can immediately alert any one or combination of fire rescue, ambulance, a designated emergency contact person, or any other persons or entity that one would contact in the event of an emergency.

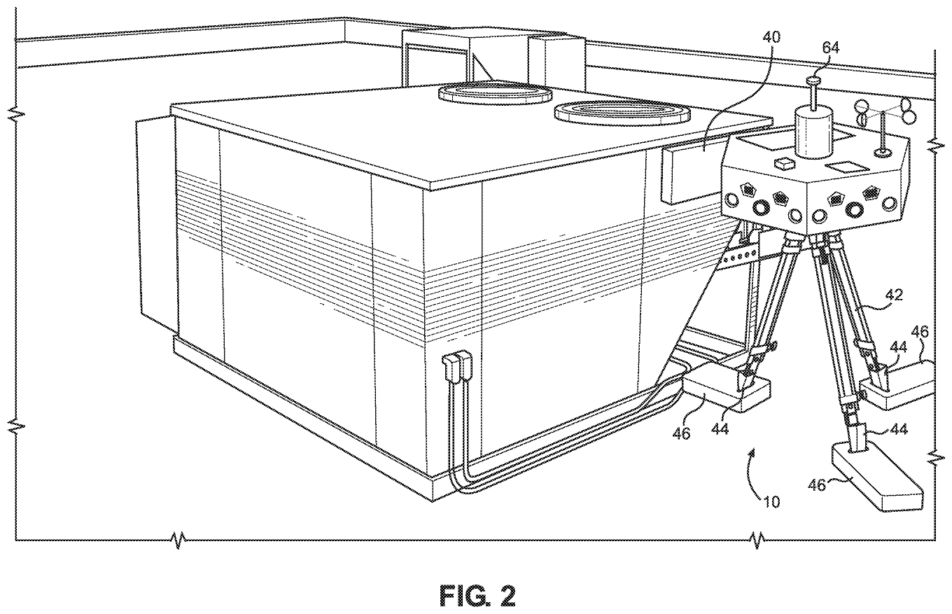

In one embodiment, as demonstrated in FIG. 2 support legs 42 have support feet 44 and are stabilized and secured utilizing counterweights 46.

As demonstrated in FIG. 2, system 10 is secured to an existing air conditioner compressor using mounting plate 40.

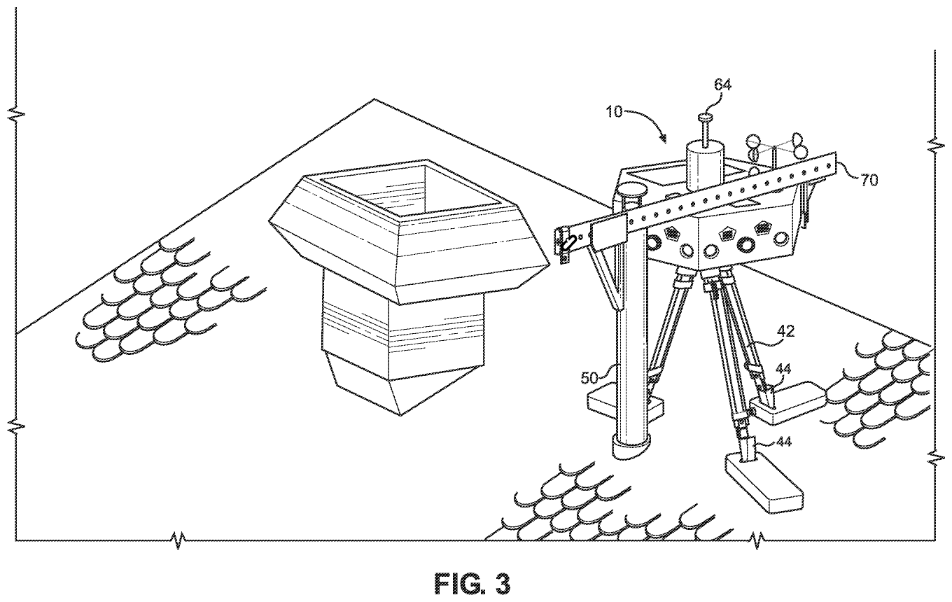

In another environment, as demonstrated in FIG. 3, an existing roof top pipe 50 has securing bracket 52 to affixed thereto where system 10 is held in place by securing bracket 52.

The system of the present invention for the contemplates main body 10 configured with communications component providing for wireless communication and external monitoring of a roof upon which main body 10 is placed.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

1. A system for roof monitoring comprising:
a main body housing constructed and arranged as a main base unit for placement on a roof;
primary components incorporated into said main body housing including an infrared detector, camera, flash detector, and carbon monoxide monitor;
computer components operatively associated with said primary components and a communications system;
legs positioned on an underside of said main body for supporting said main body; and
satellite cameras connected by Bluetooth connection or wire option to said main base unit for reporting events.

2. The system of claim 1 wherein said main body is secured into portion with counterweights on a distal end of said legs.

3. The system of claim 1 wherein said main body is secured to an existing structure on a roof where said main body is placed.

4. The system of claim 3 wherein said existing structure is an air conditioner compressor or a rooftop pipe.

5. The system of claim 1 wherein said communications system broadcasts an alert when any of said primary components are actuated.

6. The system of claim 1 wherein said communications system are configured to provide remote monitoring of all primary components.

7. The system of claim 1 wherein said communications system broadcasts an alert to emergency first responders when any of said primary components are actuated.

8. The system of claim 1 wherein said primary components further include GPS location, light beacon, motion detector or combinations thereof.

9. A system for roof monitoring consisting of:
a main body housing constructed and arranged for placement on a roof;
primary components incorporated into said main body housing including an infrared detector, camera, flash detector, and carbon monoxide monitor
computer components operatively associated with said primary components and a communications system;
legs positioned on an underside of said main body for supporting said body; and
satellite cameras connected by Bluetooth connection or wire option to said main base unit for reporting events.
